(19) United States
(12) Patent Application Publication
(10) Pub. No.: US 2024/0347480 A1
(43) Pub. Date: Oct. 17, 2024

(54) PHYSICAL UNCLONABLE FUNCTIONS WITH COPPER-SILICON OXIDE PROGRAMMABLE METALLIZATION CELLS

(71) Applicants: Michael KOZICKI, Phoenix, AZ (US); Wenhao CHEN, Folsom, CA (US)

(72) Inventors: Michael KOZICKI, Phoenix, AZ (US); Wenhao CHEN, Folsom, CA (US)

(21) Appl. No.: 18/518,196

(22) Filed: Nov. 22, 2023

Related U.S. Application Data
(63) Continuation of application No. 17/480,928, filed on Sep. 21, 2021, now Pat. No. 11,869,852.
Application No. 17/480,928 is a continuation of application No. 16/496,767, filed on Sep. 23, 2019, now Pat. No. 11,127,694.
(60) Provisional application No. 62/475,725, filed on Mar. 23, 2017.

(51) Int. Cl. H01L 23/00; H10B 63/00; H10N 70/00; H10N 70/20

(52) U.S. Cl. CPC H01L 23/573; H10B 63/80; H10N 70/023; H10N 70/026; H10N 70/041; H10N 70/245; H10N 70/826; H10N 70/8416; H10N 70/883

(57) ABSTRACT

A physical unclonable functions (PUF) device including a first copper electrode, a second electrode, and a silicon oxide layer positioned directly between the first copper electrode and the second electrode; a method of producing a PUF device; an array comprising a PUF device; and a method of generating a secure key with a plurality of PUF devices.

### CROSS-REFERENCE TO RELATED APPLICATIONS

This application is a non-provisional of and claims the benefit of U.S. Provisional Patent Application No. 62/475,725, filed on Mar. 23, 2017, the contents of which are incorporated herein by reference.

### BACKGROUND OF THE INVENTION

Internet security has become increasingly important, in part because of the rapidly growing internet of things (IoT). Many IoT devices are currently communicating on open networks with little or no security, making them vulnerable to network intrusion, including distributed denial of service (DDoS) attacks, for example. Most IoT devices, however, are based on low power system on chip (SOC) designs. Thus, full security on these devices is preferably implemented with as little circuit overhead or additional power consumption as possible to meet operational requirements of the IoT.

Current secure communications require random number generation to create a secure key. The security of the key is directly related to the randomness of the number generation. Various software approaches have been used to generate pseudo random binary sequences (PRBS), but these can be cracked with sufficient computing power. Alternatively, naturally occurring randomness in semiconductor device characteristics can provide random number generation via appropriate reading circuitry, from within an integrated circuit, for example, with the generated number being unique to each circuit. This has been demonstrated with static random access memory (SRAM) and resistive random access memory (RRAM). Arrays of these type of memories have been used as generators of Physical Unclonable Functions (PUFs).

Of particular interest are nonvolatile memory cells based on anion or cation migration through a solid electrolyte due to the prospect of low power consumption, high scalability, and multibit data storage. Operation is thought to be through a filamentary switching mechanism based on mobile oxygen vacancies. Metal ions move through, for example, a chalcogenide which acts as solid electrolyte and are reduced at an inert counterelectrode. From there, a metallic filament grows toward the oxidizable electrode and switches the initially high resistive cell to a low resistance state (on). Under reverse bias, the metallic filament is dissolved and the memory cell switches back to the high resistance state (off).

### SUMMARY OF THE INVENTION

Disclosed herein are Programmable Metallization Cell (PMC) PUF systems. Even more particularly, disclosed herein are PMC PUF systems based on copper (Cu) and silica/silicon oxide/silicon dioxide (SiO₂), both of which are commonly found in foundry complementary metal-oxide-semiconductor (CMOS) processes.

In one embodiment, the invention provides a PUF device including a first copper electrode, a second electrode, and a silicon oxide layer positioned directly between the first copper electrode and the second electrode.

In another embodiment, the invention provides a method of making a PUF device including providing an electrode, subsequently depositing a layer of silicon oxide onto the electrode, and subsequently depositing a copper film onto the layer of silicon oxide to form a copper electrode.

In yet another embodiment, the invention provides an array including a plurality of CMOS transistors and a plurality of PUF devices, which each include a first copper electrode, a second electrode, and a layer of silicon oxide positioned directly between the first copper electrode and the second electrode, where the plurality of PUF devices are positioned above the plurality of CMOS transistors.

In yet another embodiment, the invention provides a method of generating a secure key including providing an array, which includes a plurality of copper lines and a plurality of lines including W, Ni, Pt, TiN, TaN, TiW, or polycrystalline silicon, the plurality of lines being positioned perpendicular to the plurality of copper lines, where a plurality of PUF devices is formed at a plurality of intersections of the plurality of copper lines and the plurality of lines, where each of the plurality of PUF devices includes a first copper electrode, a second electrode, and a layer of silicon oxide positioned directly between the first copper electrode and the second electrode; subsequently placing each of the plurality of PUF devices into an off state; subsequently applying a positive voltage to one of the plurality of copper lines and a negative voltage or a ground voltage to one of the plurality of lines, with all other lines floating; subsequently measuring a parameter of the PUF device at the intersection of the lines; subsequently applying a negative voltage or a ground voltage to the copper line and a positive voltage to the one of the plurality of lines; and repeating the sequence for a different pair of intersecting lines.

In a further embodiment, the invention provides a system comprising an array of devices, wherein each device comprises a first copper electrode, a second electrode, and a layer of silicon oxide positioned directly between the first copper electrode and the second electrode. The array of devices is partitionable such that a portion of the devices generates information and another portion of the array provides memory storage. In one construction, the devices that generate information are activated to provide a stochastic result. In another construction, the stochastic result is provided by a change in resistance. In yet another construction, the devices that provide memory storage are forced into a deterministic state provided by a stable change in resistance. In a further construction, the array of devices is partitionable based on a change in resistance of the devices.

Other aspects of the invention will become apparent by consideration of the detailed description and accompanying drawings.

### BRIEF DESCRIPTION OF THE DRAWINGS

FIG. 1 illustrates a distribution of set (programming) voltage for a PMC array. The distribution can be divided into contiguous 0 and 1 ranges or into 0 and 1 ranges separated by a third state.

FIG. 2 shows a schematic and cross-sectional electron micrograph of an individual Cu—SiO₂ PMC structure. In the illustrated embodiment, the lower electrode is W, and the device is formed in a via hole in an isolating layer formed by PECVD between the metal films.

FIG. 3 illustrates a generation protocol for an active array.

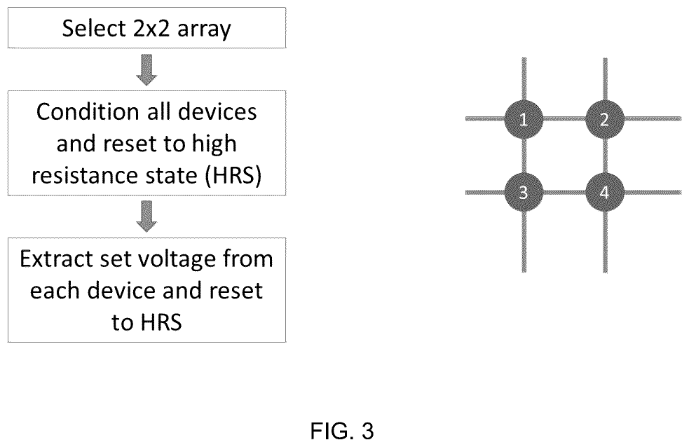

FIG. 4 shows a typical plot illustrating the set voltage of an individual PMC structure.

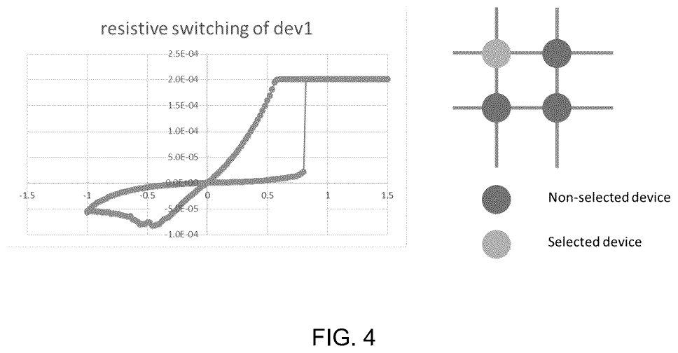

FIG. 5 shows a table that further illustrates the generation protocol of FIG. 3.

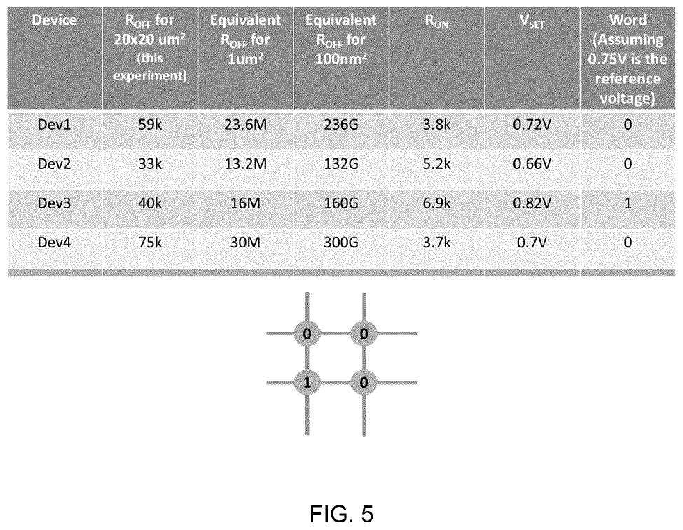

FIG. 6 shows optical micrographs of a 12×12 cross-point array of Cu—SiO₂ PMC cells with tungsten lower electrode and a single device within the array, and a schematic diagram of the cross-section of a cell. A PMC device is formed at each crossing point of the tungsten and copper lines.

FIG. 7 illustrates a generation protocol for a cross-point array.

FIG. 8 is a schematic cross-section illustration of PMC samples: a) Cu/SiO₂/Pt PMC, b) Cu/Cu:SiO₂/Pt PMC before annealing, c) Cu/Cu:SiO₂/Pt PMC after thermal annealing at 550° C. for 10 minutes.

FIG. 9 shows a typical threshold switching I-V characteristics of a Cu/SiO₂/Pt PMC.

FIG. 10 shows a) cycling of threshold switching with a 100 μA compliance current and b) a pulsing scheme showing device returning to its high resistance-state (HRS) in less than 1 ms at zero applied bias regardless of programming condition.

FIG. 11 shows a) 50 cycles bipolar memory switching of a Cu-doped device and b) the low resistance-state (LRS) retention characteristics.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

The terms “comprise(s)”, “include(s)”, “having”, “has”, “can”, “contain(s)”, and variants thereof, as used herein, are intended to be open-ended transitional phrases, terms, or words that do not preclude the possibility of additional acts or structures. The singular forms “a”, “and”, and “the” include plural references unless the context clearly dictates otherwise. The present disclosure also contemplates other embodiments “comprising”, “consisting of”, and “consisting essentially of”, the embodiments or elements presented herein, whether explicitly set forth or not.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4”. The term “about” may refer to plus or minus 10% of the indicated number. For example, “about 10%” may indicate a range of 9% to 110%, and “about 1%” may mean from 0.9-1.1. Other meanings of “about” may be apparent from the context, such as rounding off, so, for example “about 1” may also mean from 0.5 to 1.4.

The conjunctive term “or” includes any and all combinations of one or more listed elements associated by the conjunctive term. For example, the phrase “an apparatus comprising A or B” may refer to an apparatus including A where B is not present, an apparatus including B where A is not present, or an apparatus where both A and B are present. The phrase “at least one of A, B, . . . and N” or “at least one of A, B, . . . N, or combinations thereof” are defined in the broadest sense to mean one or more elements selected from the group comprising A, B, . . . and N, that is to say, any combination of one or more elements A, B, . . . or N including any one element alone or in combination with one or more of the other elements, which may also include, in combination, additional elements not listed.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

For purposes of this disclosure, the chemical elements are identified in accordance with the Periodic Table of the Elements (CAS version) and the Handbook of Chemistry and Physics (98th Ed., inside cover).

The term “silica”, as used herein unless otherwise defined, means silicon oxide SiOₓ, where x may range from greater than or equal to 1 to less than or equal to 2. More particularly, the term “silica” may refer to SiOₓ where x equals a single value (within normal experimental tolerance) from 1 to 2, or “silica” may refer to SiOₓ where x is a mixture of values from 1 to 2. Even more particularly, the term “silica” may refer to SiOₓ where x equals about 1.4.

The term “silicon oxide”, as used herein unless otherwise defined, means SiOₓ, where x may range from greater than or equal to 1 to less than or equal to 2. More particularly, the term “silicon oxide” may refer to SiOₓ where x equals a single value (within normal experimental tolerance) from 1 to 2, or “silicon oxide” may refer to SiOₓ where x is a mixture of values from 1 to 2. Even more particularly, the term “silicon oxide” may refer to SiOₓ where x equals about 1.4.

A PUF is embodied in a physical structure, such as a memory array, and has the characteristic of being easy to evaluate but hard to predict due to the randomness of the underlying mechanism. For practical security applications, a PUF system should be simple to make but difficult to duplicate, even when the exact manufacturing process that produced it is known. Randomness occurs naturally at the nanoscale in materials that make up memory arrays, which leads to randomly distributed cell characteristics in these devices.

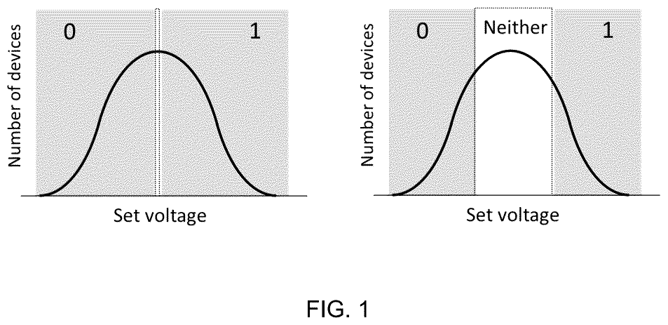

Programmable resistance devices, such as the Programmable Metallization Cell (PMC), exhibit subtle random differences in operational parameters from cell to cell, due to the stochastic nature of the formation of the conducting pathway. For example, the voltage at which the devices transition from a high resistance “off” state to some low resistance “on” state, the set voltage, varies randomly across an array of PMCs. This parameter can be partitioned into ranges representing logic 0 and logic 1, with the possibility of intermediate states being defined in an intervening range, as shown in FIG. 1. In this approach, the length of a random word is directly proportional to the size of the array.

### PMC Arrays and PUFs

PUFs can strengthen the authentication methods of IoT elements, because they act as “digital signatures” of the hardware; to support security protocols PUFs can also operate as data-base-free authentication devices, as no secret keys or passwords have to be stored in the IoT; the cost structure of most PUFs is, in general, very low. PUFs exploit intrinsic manufacturing variations introduced during the fabrication of the electronic components of the IoTs. Variations such as critical dimensions, doping levels of semiconducting layers, and threshold voltages make each component unique and identifiable from each other. The PUF's underlying mechanism is the creation of a large number of challenges (i.e. input), responses (i.e. output), and pairs (called CRPs) which are unique to each device. Once deployed during the authentication cycles, PUFs are queried with challenges. The authentication is granted when the rate of correct matching responses is statistically high enough. PUFs can be generated with several components, such as ring oscillators and circuits with gate delays with field-programmable gate array (FPGA), static random access memories (SRAMs), sensors and microelectromechanical systems (MEMS) devices, Flash memories, magnetic memories, and various resistive random access memory (RAM) components.

However, PUFs can have (i) a lack of stability of the physical parameters that creates high CRP error rates due to natural drifts or noisy conditions, and (ii) insufficient secret properties of the PUFs that make them vulnerable through side channel analysis by hackers. PUFs based on existing technologies often struggle to deliver in these two areas, and this is because these two limitations are often in conflict with each other: strong PUFs can have low CRP error rates but be too easy to analyze, while weak PUFs can have high CRP error rates and be well protected from side channel analysis. PMCs are attractive because their cells operate at extremely low voltage and low power, below the detectable level of side channel analysis.

Unlike most resistive switching elements, PMC devices can operate in the pico-joule range. The state of a PMC is defined by the formation of a conductive filament (CF) within a solid electrolyte encased between two electrodes. When a CF is formed, a low resistive state (LRS) is established. In the absence of a CF, the memory cell has high resistive states (HRS), orders of magnitude higher than the LRS. The programing voltage to form CFs, the Vₛₑₜ, is typically in the 0.1 V to 0.6 V range. This is 2 to 20 times lower than the programming voltage of other resistive switching devices, and 100 times lower than Flash memory. Unlike Flash, PMC has low capacitance, which makes the read operation fast, in the 1 ns to 10 ns range, and allows constant current sensing. As a result, side channel analysis, such as differential power and electromagnetic interference analysis, are highly ineffective in extracting confidential information.

### PMC PUF Systems

PMC devices exhibit subtle random differences in operational parameters from cell to cell, due to the stochastic nature of the formation of the conducting pathway. The voltage, for example, at which the devices transition from a high resistance off state to some low resistance on state, the set voltage, varies randomly across an array of PMCs. This parameter can be partitioned into ranges representing logic 0 and logic 1, with the possibility of intermediate states being defined in an intervening range, as shown in FIG. 1. In this approach, the length of a random word is directly proportional to the size of the array.

Although some material systems exhibit switching behavior, very few are easily integrated with CMOS logic. In certain embodiments, the invention disclosed herein is a PMC PUF system based on copper and silicon oxide, both of which are commonly found in foundry CMOS processes. This enables a simple and inexpensive addition of sophisticated security features, as described above, into almost any integrated circuit.

Additionally or alternatively, certain embodiments can operate with very low current, leading to low power/low energy performance. For example, a full switching operation may require about 3 V and about 100 pA for about 400 μs, which gives 300 μW and 120 nJ for power and energy, respectively. In certain embodiments, the operating current may be as low as about 10 nA. In certain other embodiments, the operating current may be as low as about 10 pA, such as for certain copper-silicon oxide devices.

In certain embodiments, PUF generation may utilize lower power and energy because, at least in part, complete switching is not required to generate random numbers (i.e., set voltage can be determined without fully switching a device to a low resistance on state). In certain embodiments, using very small currents and voltages which alter the metal concentration in a region between the electrodes but which does not result in a continuous stable filament results in volatile device operation, which may dispose the need for pre-erase and/or post-erase steps, as described below.

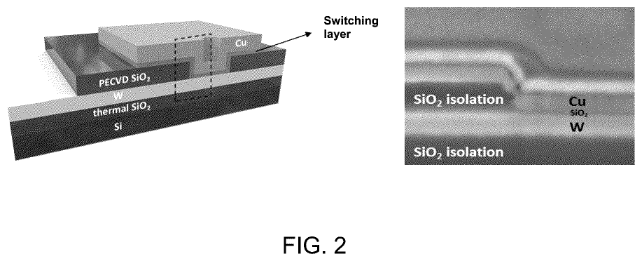

As illustrated in FIG. 2, a copper-silicon oxide cell may comprise a “lower” electrode, a switching layer, and an “upper” electrode. In certain embodiments, the lower electrode is a tungsten (W) electrode. In certain embodiments, the switching layer is a thin layer of silicon dioxide (SiO₂). In certain other embodiments, the switching layer is a thin layer of silicon oxide (SiOₓ, where x can range from 1 to 2; for example, x equals about 1.4) or silica. In certain embodiments, the upper electrode is a copper (Cu) electrode. The metal layers may be isolated from each other in non-device regions by a relatively thick layer of a dielectric. In certain embodiments, this dielectric is SiO₂ or silicon oxide.

A variety of lower electrodes may be used. The lower electrode material is preferably relatively electrochemically inert, such as tungsten (W), nickel (Ni), platinum (Pt), titanium nitride (TiN), tantalum nitride (TaN), titanium tungsten (TiW), or polycrystalline silicon (poly-Si), for example. A variety of dielectric materials may be used for the isolation, such as thick SiO₂, Si₃N₄, or various dielectric polymers, for example. The isolation material may be formed by a variety of methods commonly known in the art.

In certain embodiments, a copper-silicon oxide PMC structure may be formed in a via hole. More particularly, a copper-silicon oxide PMC structure may be formed in a via hole in a plasma-enhanced chemical vapor deposition (PECVD) isolating layer between metal films. Alternatively, a copper-silicon oxide PMC structure can be “planar” instead of recessed into a via hole, with the lower electrode surface being level with the top surface of the isolating dielectric and the switching layer and top electrode being relatively flat. In other words, the structure has a planarized lower electrode such that both the switching layer and the top electrode may be flat.

A PMC device may switch by formation of a Cu bridge within the switching layer between electrodes. The Cu bridge may form upon application of an appropriate voltage. If the silicon oxide switching layer is relatively porous and amenable to transport of Cu ions within its structure, the switching may occur at low energy and/or without damaging the PMC device (e.g., breakdown).

The switching layer may be formed by physical vapor deposition (PVD). An isolated lower electrode structure may be formed first. A thin layer of silicon oxide may be formed using PVD, including sputtering or evaporation. In certain embodiments, the thin layer of silicon oxide is about 15 nm thick. The PVD conditions may be chosen to ensure formation of a relatively low density silicon oxide film. In certain embodiments, a relatively low density silicon oxide film may be formed by a high deposition rate. Then, a thin Cu film may be deposited. In certain embodiments, the thin Cu film is about 50 nm thick. Additionally or alternately, the thin Cu film may be deposited by sputtering. Then, an annealing step may be performed. Annealing may drive Cu from the thin Cu film into the oxide (e.g. silicon oxide or SiO₂) layer. In certain embodiments, this annealing step occurs at about 500° C. for about 10 minutes. In certain other embodiments, this annealing step occurs at about 500° C. to about 600° C. for about 10 minutes to about 20 minutes. Additionally or alternately, the annealing step may occur in pure N₂, N₂/H₂, or Ar gas. These processes can be performed with equipment or techniques commonly known in the art, such as RF sputter deposition (for silicon oxide), DC sputter deposition (for Cu), inert gas annealing furnace, lithography, and/or reactive ion etching (RIE) (thin Cu may be ion milled) for patterning, for example.

As an example, the PVD deposition rate may be about 1 Å/sec, the deposition temperature may be about room temperature, and the deposition pressure may be about 10⁻⁶ torr. These PVD conditions may result in a low density silicon oxide film having a density of about 2.08 g/cm³. For comparison, the normal density of amorphous silicon dioxide is about 2.2 g/cm³. In certain embodiments, the density of the silicon oxide film is less than or equal to about 2.20 g/cm³, about 2.15 g/cm³, or about 2.10 g/cm³. Alternately, a low density may be achieved by using plasma enhanced chemical vapor deposition (PECVD) at a low temperature, such as at less than 200° C., for example.

Alternately, the switching layer may be formed by chemical vapor deposition (CVD). An isolated lower electrode structure may be formed first. A thin layer of silicon oxide may be formed using remote plasma chemical vapor deposition (RPCVD). In certain embodiments, the thin layer is about 5 nm thick. Additionally or alternately, the RPCVD may be at about 200° C. Then, a thin Cu film may be deposited. In certain embodiments, the thin Cu film is about 50 nm thick. Additionally or alternately, the thin Cu film may be deposited by sputtering. These processes can be performed with equipment or techniques commonly known in the art, such as an RPCVD system (for silicon oxide), DC sputter deposition (for Cu), lithography, and/or RIE (thin Cu may be ion milled) for patterning, for example.

In certain embodiments, the thin layer of silicon oxide may have a thickness of about 5 nm to about 20 nm, about 10 nm to about 20 nm, about 15 nm to about 20 nm, about 5 nm to about 15 nm, about 5 nm to about 10 nm, about 10 nm to about 20 nm, or about 10 nm to about 25 nm. In certain embodiments, the thin layer of silicon oxide may have a thickness of about 1 nm, about 2 nm, about 3 nm, about 4 nm, about 5 nm, about 6 nm, about 7 nm, about 8 nm, about 9 nm, about 10 nm, about 11 nm, about 12 nm, about 13 nm, about 14 nm, about 15 nm, about 16 nm, about 17 nm, about 18 nm, about 19 nm, or about 20 nm.

In certain embodiments, the thin copper film may have a thickness of about 20 nm to about 200 nm, about 20 nm to about 180 nm, about 20 nm to about 160 nm, about 20 nm to about 140 nm, about 20 nm to about 120 nm, about 20 nm to about 100 nm, about 20 nm to about 80 nm, about 20 nm to about 60 nm, or about 20 nm to about 40 nm. In certain embodiments, the thin copper film may have a thickness of about 20 nm, about 30 nm, about 40 nm, about 50 nm, about 60 nm, about 70 nm, about 80 nm, about 90 nm, about 100 nm, about 110 nm, about 120 nm, about 130 nm, about 140 nm, about 150 nm, about 160 nm, about 170 nm, about 180 nm, about 190 nm, or about 200 nm.

Relatively thick switching layers may require a “forming” step in which a switchable filament is formed at a voltage above the normal operating level. In certain embodiments, relatively thick can be defined as a layer having a thickness of greater than about 10 nm, thickness being measured perpendicular to the planar surface of the layer. In the case of a 15 nm thick SiO₂ layer, for example, the forming voltage is over 3 V. This same forming voltage drops to less than 2 V after an annealing step to drive Cu into the oxide. A lower forming voltage is advantageous for in low power/low voltage circuits. In certain embodiments, a normal operating DC set voltage is in the order of 0.5 V. This set voltage may rise when short pulse programming is used, however. One advantage of a relatively thick switching layer is that the off-state resistance can be extremely high, such as greater than about 1 GΩ, for example. Very thin switching layers (e.g., less than about 10 nm), on the other hand, may not require an annealing step during production. This may be true in particular for a highly porous switching layer, such as an RPCVD oxide, for example. The off-state resistance is also typically lower (e.g., 100 kΩ) compared to when the switching layer is relatively thick.

In certain embodiments, a PMC device may be fabricated in metal layers above a CMOS transistor. In certain other embodiments, a PMC device may be fabricated in metal layers connected to a CMOS transistor. In yet other embodiments, a PMC device may be fabricated in metal layers in direct contact with a CMOS transistor. These may constitute an “active” array in which each PMC device fabricated in metal layers above CMOS transistors is accessed via its own transistor (i.e., the individual transistor below each PMC device). In an active array, each binary digit in a secure word may be generated by an individual “1T-1R” (one transistor, one resistor) cell so that the number of cells in the array is equal to the word length. A device parameter, such as set voltage or on-state resistance, for example, may be determined for each cell by turning on its corresponding transistor and performing a measurement with all other transistors turned off.

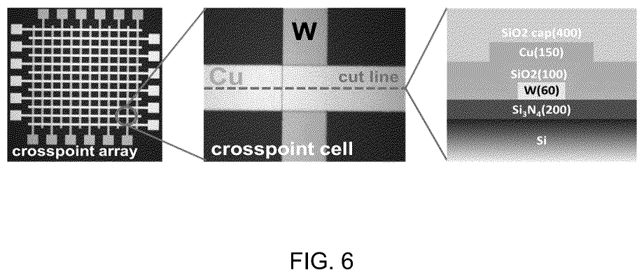

Alternatively, PMC devices can be arranged in a cross-point array, as illustrated in FIG. 6. This may constitute a “passive” array. The copper-silicon oxide PMC elements may be formed at each intersection of, for example, W (column) and Cu (row) lines. In certain embodiments, the non-Cu line may be a material other than W. These PMC elements may not be accessed via a transistor, as described above, which may make the overall structure simpler to produce. Additionally, multiple arrays may be stacked, saving physical area in an integrated circuit, for example. Such a crosspoint array may employ non-linear elements, such as diodes, for example. These non-linear elements may prevent on-state (low resistance) devices from shorting rows and columns together. In certain embodiments, no non-linear elements are required. This crosspoint approach has the advantage of being an extremely convenient implementation of a PUF within an integrated circuit.

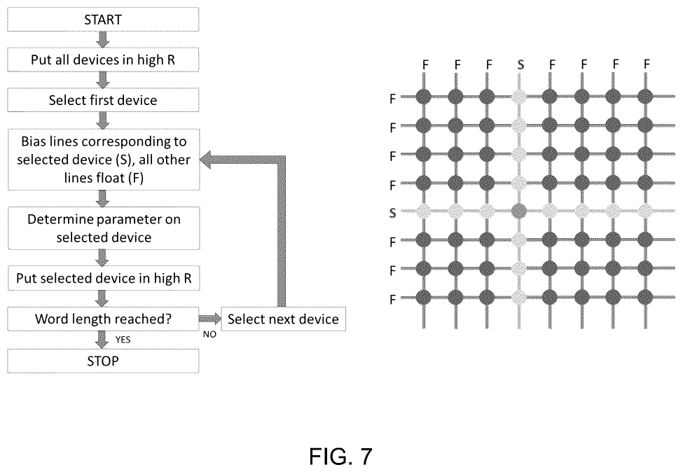

In the crosspoint concept, each individual cell may be accessed with all others reset to their off state. This may reduce “sneak path” currents through non-selected cells, since the devices are essentially connected together. As illustrated in FIG. 7, a generation protocol may involve placing all devices in their off state, accessing a device by applying a positive voltage to its corresponding Cu line and a negative voltage or ground voltage to its corresponding W line with all other lines floating, measuring a parameter of interest for the selected device, erasing this device by applying a negative voltage or ground voltage to its corresponding Cu line and a positive voltage to its corresponding W line, and repeating this sequence for the next selected device.

In other embodiments, the need for pre-erase and/or post-erase steps (e.g., applying a negative or ground voltage after a positive voltage) can be avoided with volatile device operation. Volatile/transient resistance states can be created in at least two ways: a) by using very small currents and voltages which alter the metal concentration in a region between the electrodes but which do not result in a continuous and stable filament or b) by creating a structure that results in a high concentration gradient between the on state conducting region and the surrounding material so that the pathway dissolves spontaneously. The low current/low voltage method, which is applicable to any device structure, is of particular benefit to high security applications as it is more resistant to side channel attacks due to the low programming energy used.

Volatile devices use a switching oxide that does not contain a high copper concentration (i.e., it is relatively undoped, e.g., less than about 1 at % Cu in the oxide) so that a copper-rich pathway will spontaneously dissolve back into the surrounding ion conductor.

### Example

A device which contains a thin layer of deposited silicon dioxide, silicon oxide, or silica between two electrodes, one of which is copper, can be reversibly switched between high and low resistance states upon application of an appropriate voltage. Subtle differences in operational parameters exist between such devices due to the stochastic nature of the switching process. In particular, the precise voltage at which each device transitions from its high resistance off state to a low resistance on state will vary randomly from device to device. This parameter can be obtained from several devices by electronic means and the results partitioned into ranges representing logic 0 and logic 1, so that an array of devices can generate a random binary word. The word is impossible to predict a priori, as complex and variable atomic scale processes in multiple nanoscale devices are responsible for its generation, but it is simple to read by electrical means. A physical entity that has a property which is easy to evaluate but hard to predict lies at the heart of the physical unclonable function concept, and these entities have considerable utility in cryptography.

A PUF based on copper and silicon oxide enables simple and inexpensive addition of sophisticated security features into virtually any integrated circuit, as these materials are commonly used in foundry CMOS processes. These devices also operate with low current and voltage, leading to low power/low energy performance. In addition to their process compatibility, copper-silicon oxide devices may be readily fabricated in the metal layers above the CMOS transistors in the form of a cross-point array (as described above), reducing silicon real estate and corresponding implementation cost and design complexity. In a cross-point array, all devices are essentially interconnected so each cell should typically be evaluated with all others placed in their off state to reduce currents through non-selected cells that may confuse the result.

The combination of copper-silicon oxide devices in a cross-point array leads to the possibility of extremely complex (large word length) PUFs that are low cost and readily added to silicon circuitry.

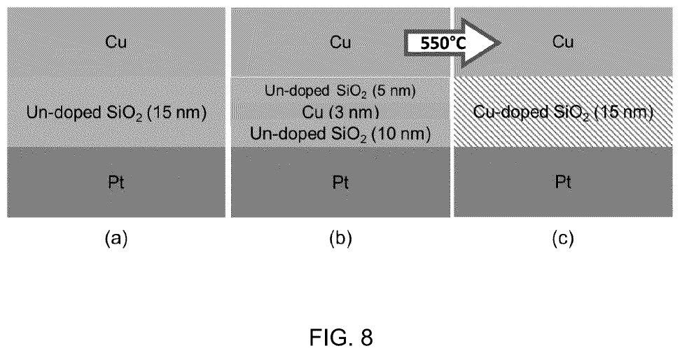

PMC devices with a Cu/SiO₂/Pt vertical stack were fabricated on Si₃N₄ coated 4 inch Si wafers. First, a stack of 5 nm Ti, 90 nm Pt, and 5 nm Ti was sequentially e-beam evaporated as a common inert electrode, followed by a 100 nm PECVD SiO₂ deposition. Photolithography and wet etching was then performed on this PECVD layer to create holes for the devices and to expose the inert electrode pads. The wafers were then divided into two pieces to allow different process flows for each half. One half was transferred to a PVD chamber and a 15 nm SiO₂ switching layer was e-beam evaporated. For the other half wafer, a tri-layer stack of 10 nm SiO₂/3 nm Cu/5 nm SiO₂ was sequentially e-beam evaporated without breaking the vacuum. The cumulative thickness of the SiO₂ was kept the same for both scenarios. The tri-layer devices were then annealed at 550° C. for 10 minutes in a nitrogen ambient to thermally diffuse the sandwiched Cu layer into the surrounding SiO₂ layers. No thermal annealing was performed on the single oxide layer samples. Photolithography was then performed on both pieces to define the active electrode patterns by Cu film deposition and a lift-off process. The non-annealed and therefore undoped PMC samples are labeled as “Cu/SiO₂/Pt” and the annealed and Cu-doped PMCs are labeled as “Cu/Cu:SiO₂/Pt”, as schematically shown in FIG. 8.

For electrical measurements, a high speed transistor was connected in series with the PMC device to limit the transient current overshoot during device conditioning and programming. The active electrode was biased, the inert electrode was connected to the drain of the transistor, and the source of the transistor was grounded. The compliance current was controlled by the gate voltage of the transistor.

In resistive switching memory, the low resistance-state (LRS) value can be adjusted by altering the compliance current during a dc set operation; the LRS decreases with the increase of compliance current. Prior to the complete bridging of the electrodes by the filament, the LRS decrease is caused by the vertical growth of filament which narrows the tunneling gap between the filament tip and electrode. Once the filament contacts the opposing electrode, any further reduction in the LRS is a result of filament radial growth. Stability requirements for the conductive filament vary from application to application. For example, a robust filament is necessary for non-volatile memory applications while a weak filament is desirable for applications such as low refresh dynamic memory, inherent selectors for non-destructive readout of complementary resistive switches, or, as in the present exemplary embodiment, threshold switches operating as a selector device in crosspoint arrays. The stability of the LRS is dependent on the compliance current with the LRS being most volatile at a small current (typically less than about 10 μA), while non-volatility ensues if the compliance current is sufficiently large (typically greater than about 50 μA). A possible explanation for the volatile switching is the formation of unstable, narrow, or even discontinuous conductive filaments at low compliance currents.

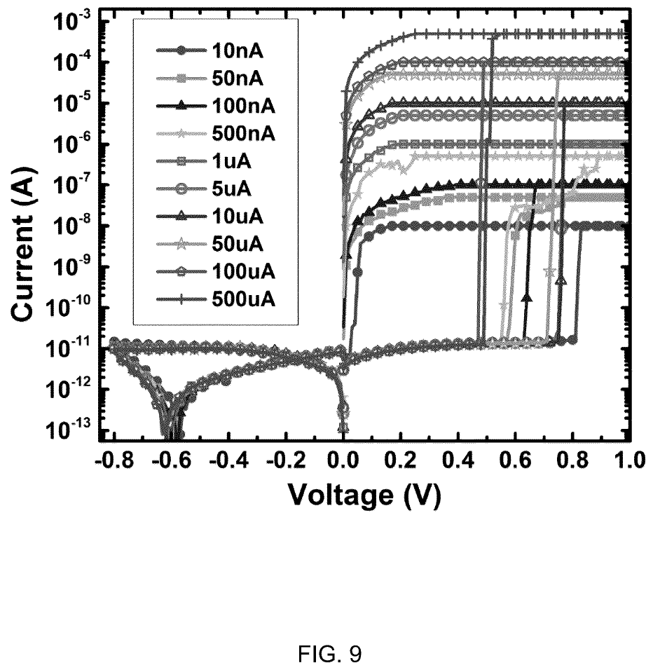

In order to examine the compliance current effect on the Cu/SiO₂/Pt PMC device, a 5×5 μm² device was swept with a range of compliance currents ranging from 10 nA to 500 μA. The results are shown in FIG. 9. For each test, the Cu electrode voltage was first swept from 0 V to 1 V and back to 0 V in one continuous double sweep. Then the Cu electrode voltage was swept from 0 V to 0.8 V and returned to 0 V. As shown in FIG. 9, the device switched from the HRS to the LRS at a positive threshold voltage (Vth) between 0.5 V and 0.8 V, at which point the current rises rapidly to the compliance limit. The device's LRS value is maintained when the positive voltage is sufficiently large; but the filament ruptures spontaneously when the voltage is reduced to a small, typically positive voltage, thus restoring the device to its HRS condition. This volatility is clearly shown in FIG. 9 by the very low currents measured over the reverse bias range (between 0 V and 0.8 V). In all cases the device has spontaneously transitioned to the HRS regime. The results demonstrate that volatility is independent of compliance current up to 500 μA for the Cu/SiO₂/Pt PMC. Moreover, the threshold switching behavior over the 0 to 1 V sweep resembles the I-V characteristics of a diode in breakdown. A rectifying ratio of about 5×10⁷ can be obtained if the current is read at 0.8 V with a 500 μA programming/compliance current. The rectifying ratio can be further increased in smaller devices since the HRS resistance is inversely proportional to the device area while LRS resistance is not dependent on device size. Such a high rectifying ratio shows that this device may be useful as a sneak path blocking selector.

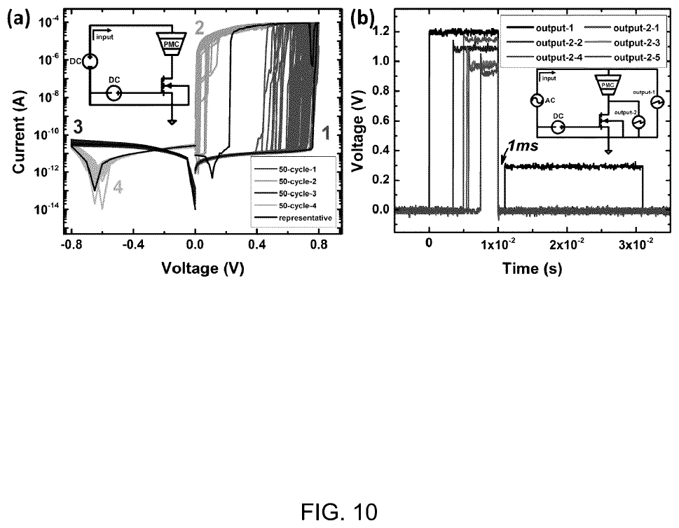

The HRS stability of the Cu/SiO₂/Pt device was also investigated because this is important for the suppression of sneak path currents. The device was dc swept for 50 cycles with a relatively high current (for normal resistive device operation) compliance of 100 μA in order to accelerate the degradation of the HRS. The test schematic is illustrated in the inset of FIG. 10a. The switching current is limited by the saturation current of the transistor. The voltage was swept between −0.8 V and 0.8 V and the labeled numbers indicate the sweeping sequence in each cycle. As can be seen in FIG. 10a, the filament spontaneously ruptures even when the positive voltage is still applied and no memory trace was found in the negative voltage side for all repeated cycles. The HRS current is below 10⁻¹⁰ A out to −0.8 V and is tightly distributed from cycle to cycle with no obvious degradation being observed. The small variation in HRS current indicates that no significant Cu residues are left in the filament region after it dissolves. It should be noticed that the threshold voltage is not tightly distributed in FIG. 10a. Such variation poses threats to reliable reading/programming operations when the memory cell is integrated, but this problem may be alleviated through process control during device fabrication. Since this device type switches to the HRS while a small positive bias is applied, it is likely that the Cu atoms from the filament are absorbed by the surrounding SiO₂ matrix, causing conductive pathways to disappear. Engineering the electrolyte layer to be intentionally Cu deficient enables diffusion processes to support rapid filament dissolution.

Another important property of threshold switching is the volatilizing speed, i.e., the speed of filament rupture when the voltage bias is removed. A pulse test scenario was conducted to assess this on five Cu/SiO₂/Pt devices and the results are shown in FIG. 10b. The test schematic is illustrated in the inset of FIG. 10b. A compliance current of 100 μA was set with the transistor. Write pulses were first generated to program the devices to their LRS followed by smaller amplitude but longer read pulses, as shown in FIG. 10b. No bias was applied in the period between the write and read pulse. The write pulse was 1.2 V high and 10 ms long, the read pulse was 0.3 V high and 20 ms long, and a minimum of 1 ms time gap was chosen in order to clearly distinguish the effects of the write and read pulses. By comparing the waveform received by channel-1 (output-1) and channel-2 (output-2) of an oscilloscope, it could be seen that the devices were programmed to their LRS in a few milliseconds. The LRS were randomly programmed to be 390 Ω, 860 Ω, 1.83 kΩ, 2.04 kΩ and 2.45 kΩ, and, all of the devices quickly recovered to their HRS in less than 1 ms once the voltage was removed as a negligible readout voltage was observed in output-2 over the read time interval.

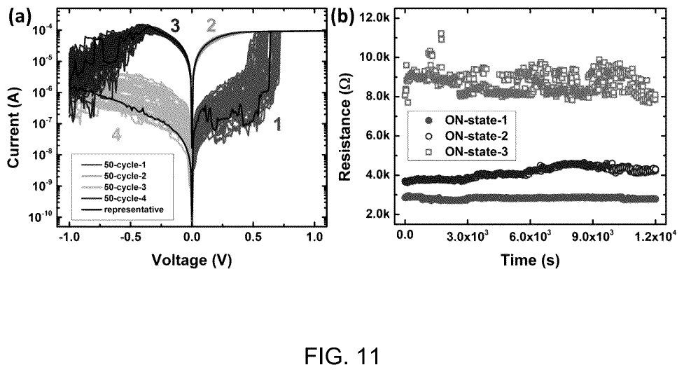

The I-V characteristics of a Cu/Cu:SiO₂/Pt PMC device are given in FIG. 11a, using the same test setup shown in the inset of FIG. 10a. The device was cycled 50 times using voltage sweeps with a 100 μA compliance current. It can be seen from FIG. 11a that the Cu doped device shows bipolar resistive switching behavior. The conductive filament is maintained even with a negative bias applied and can only be dissolved when the applied negative bias is large enough (less than −0.5 V). In addition, the reset current is comparable to the set current which indicates good control of transient current overshoot during programming. However, the HRS resistance of Cu/Cu:SiO₂/Pt device is orders of magnitude lower than that of Cu/SiO₂/Pt devices and it possesses a larger cycle-to-cycle variation.

The retention characteristics of the LRS were assessed and the results are shown in FIG. 11b. The device was switched to three different LRS values, i.e., 3 kΩ, 4 kΩ, and 9 kΩ. Each device resistance was sampled for 1.2×10⁴ seconds at room temperature. During the testing, a 100 mV read voltage was applied every 10 seconds. It can be seen that although fluctuations were observed for the largest LRS, a clear separation between the different LRS values is evident. FIG. 11b demonstrates that the LRS is stable for a range of programmed values, which suggests that the Cu doped PMC device may be a good technology for non-volatile memory applications.

It is worth noting that the volatile threshold switching behavior is preserved in the Cu/SiO₂/Pt devices even for a compliance current as high as 500 μA. This is more than enough to achieve non-volatile switching in resistive memory devices. In the undoped devices, simply increasing compliance current is not enough for the device to exhibit memory switching, i.e., stable filament formation. The volatility of the Cu/SiO₂/Pt device may be due to the porous structure of the e-beam evaporated SiO₂ and the large concentration gradient between the Cu-rich conducting region and the surrounding (undoped) oxide, both of which allow fast dissolution of the Cu filament. It should be mentioned that absorbed moisture in porous oxides can also be responsible for filament instability. Cyclic voltammetry (CV) studies show that an electromotive force (emf) exists in the presence of moisture in PMC devices, and such emf creates an additional voltage that oxidizes the Cu filament and impacts LRS retention. Thermal doping of the SiO₂ with Cu for the Cu/Cu:SiO₂/Pt PMC aids in the suppression of this volatility. By thermal doping, not only is the concentration gradient reduced, but the diffusion coefficient is lowered by decreasing the probability of ions “finding” vacant sites in the otherwise porous oxide. Thermal treatments can also reduce the emf influence by reducing the moisture concentration in the SiO₂. HRS fluctuation in the Cu/Cu:SiO₂/Pt device might be caused by the randomly distributed Cu residues left in the local conductive region after reset, which also confirms that the diffusion of Cu atoms was greatly suppressed by thermal doping.

Considering that the selector is strongly rectifying in the voltage range used, a 1S1R configuration would only suit unipolar memories where programing and erasing occurs with the same voltage polarity. For bipolar switching devices as shown in FIG. 11a, a 2S1R configuration, with two selectors connected in an anti-parallel configuration, would be required for a successful erase operation.

It should be kept in mind that the embodiments described herein are only presented by way of example and should not be construed as limiting the inventive concept to any particular physical configuration. Although primarily illustrated as a PUF device capable of information generation, it should be appreciated that the disclosed device could take a variety of other forms, operations, or applications, for example, a memory device capable of information storage. Rather than stimulating the device to produce a stochastic response and thereby generate a random key (i.e., information generation), the device could be stimulated to produce a deterministic response, changing the device from one resistance state to another (i.e., information storage). For example, an array of copper-silicon oxide devices can be partitioned such that part of the array is used for information generation (PUF) and part of the array is used for information storage (memory). The partitioning could be either hardware-based (e.g., connections) or software-based (e.g., programming). The partitioning could range from 0% PUF/100% memory to 100% PUF/0% memory, depending on the desired application. For example, a partitioning of greater than 50% PUF may be desirable when generating a very long key, where the remaining memory part could be used to store information useful to the operation of the system.

Various features and advantages of the invention are set forth in the following claims.

1-13. (canceled)

14. An array comprising:
a plurality of complementary metal-oxide-semiconductor (CMOS) transistors; and
a plurality of PUF devices each comprising
a first copper electrode,
a second electrode, and
a layer of silicon oxide positioned directly between the first copper electrode and the second electrode;
wherein the plurality of PUF devices are positioned above the plurality of CMOS transistors.

15. An integrated circuit comprising the array of claim 14.

16.-34. (canceled)

35. The array of claim 14, wherein the second electrode of one of the PUF devices comprises W, Ni, Pt, TiN, TaN, TiW, silicon, or polycrystalline silicon.

36. The array of claim 14, wherein one of the PUF devices comprises an insulating layer positioned directly between the first electrode or the second electrode and a circuit.

37. The array of claim 36, wherein the insulating layer comprises SiO₂, Si₃N₄, or a polymer.

38. The array of claim 14, wherein a switching operation requires less than or equal to 3 V and less than or equal to 100 pA for less than or equal to 400 μs.

39. The array of claim 14, wherein each one of the plurality of PUF devices is in direct contact with one of the plurality of CMOS transistors.

40. The array of claim 39, wherein one of the plurality of PUF devices is in direct contact with the CMOS transistor of the plurality of CMOS transistors positioned below the one PUF device.

41. A method of generating a secure key comprising:
(a) providing the array of claim 14;
(b) subsequently placing one of the CMOS transistors in the array into an on state while all other CMOS transistors in the array are in an off state;
(c) subsequently measuring a parameter of the PUF device positioned above the one CMOS transistor that is in the on state in step (b); and
(d) repeating the sequence defined by steps (b) through (c) for a different pair of one of the CMOS transistors and one of the PUF devices in the array.

42. The method of claim 41, wherein the secure key has a length equal to a number of cells formed in the array, each cell formed by one of the CMOS transistors and one of the PUF devices in the array.

43. The method of claim 41, wherein measuring the parameter includes measuring a voltage of the PUF device.

44. The method of claim 41, wherein measuring the parameter includes measuring a resistance of the PUF device.
